(19) United States
(12) Patent Application Publication
(10) Pub. No.: US 2004/0265435 A1
(43) Pub. Date: Dec. 30, 2004

(54) Antibacterial wrapping materials

(75) Inventors: Masahiko Kurauchi, Kawasaki-shi (JP); Kiyonori Furuta, Kawasaki-shi (JP); Hiroyuki Sato, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO., INC., Tokyo (JP)

(21) Appl. No.: 10/834,108

(22) Filed: Apr. 29, 2004

Related U.S. Application Data
(63) Continuation of application No. PCT/JP02/11244, filed on Oct. 29, 2002.

(30) Foreign Application Priority Data
Nov. 16, 2001 (JP) 351078/2001

(51) Int. Cl. C12C 1/027

(52) U.S. Cl. 426/106

(57) ABSTRACT

Wrapping material and underlays in which a partial ester of at least one basic amino acid with cellulose or a salt thereof is used as a constituting component have excellent antibacterial properties and a high safety. Specific examples of the partial ester of at least one basic amino acid with cellulose include a partial ester of lysine with cellulose, a partial ester of arginine with cellulose, a partial ester of ornithine with cellulose, and a partial ester of histidine with cellulose.

### CROSS REFERENCES TO RELATED APPLICATIONS

This application is a continuation of International Patent Application No. PCT/JP02/11244, filed on Oct. 29, 2002, and claims priority to Japanese Patent Application No. 351078/2001, filed on Nov. 16, 2001, both of which are incorporated herein by reference in their entireties.

### BACKGROUND OF THE INVENTION

1. Field of the Invention

The present invention relates to wrapping materials and underlays which have excellent antibacterial properties and a high safety. The present invention further relates to methods for preparing such wrapping materials and underlays, methods of using such wrapping materials and underlays, and packaged foods in which the package comprises such a wrapping material or underlay.

2. Discussion of the Background

In recent years, many novel antibacterial products have been put on the market in various fields due to public concern about infection by methicillin-resistant Staphylococcus aureus (MRSA) and enteropathogenic Escherichia coli O-157. With regard to wrapping materials, when it is taken into consideration that they also affect the safety of the product, an antibacterial property is one of the important functions in view of prevention of infectious diseases.

Quite a lot of techniques have been disclosed for wrapping materials and underlays to which antibacterial property is imparted and, since the product which is to be wrapped is directly eaten particularly in the field of wrapping materials for foods and underlays for foods, various attempts for their development have been carried out. In most of them, an antibacterial agent of a metal type represented by silver is kneaded (e.g., Japanese Patent Laid-Open No. 10/310,671) or an organic antibacterial agent represented by an isothiocyanate ester is applied to or kneaded into the material of a synthetic resin type (e.g., Japanese Patent Laid-Open No. 10/034,791). However, materials of a synthetic resin type may have a detrimental impact on environment due to their low biodegradability and are not always desirable.

On the other hand, among the disclosed techniques, there are a few wrapping materials and underlays in which materials of a cellulose type including wood and paper are used and, in Japanese Patent Laid-Open No. 03/000,898 for example, paper having an antibacterial activity in which metal salt of a long-chain acyl amino acid is attached is disclosed. In Japanese Patent Laid-Open No. 04/021,614, there is disclosed a wrapping material for keeping the freshness of perishable foods, etc. prepared by attaching an aqueous extract of soil to cloth, paper, etc. In Japanese Patent Laid-Open No. 07/020,515, there is disclosed a method for an antibacterial treatment of a wood product in which fine glass particles prepared by a fine pulverization of glass to which silver oxide is added are permeated into tissues such as wooden box for wrapping the food. In Japanese Patent Laid-Open No. 08/100,395, there is disclosed an antibacterial and antifungal paper in which ceramics carrying silver are used as a material therefor. In Japanese Patent Laid-Open No. 09/191,822, there is disclosed a preservation material for perishable foods in which a sheet prepared by application of horseradish oil or allyl isothiocyanate to a water-absorbing sheet such as paper, cloth, and nonwoven fabric is a constituting element. In Japanese Patent Laid-Open No. 10/001,897, there is disclosed an antibacterial paper compounded with a silver-containing antibacterial agent and an alkaline earth metal salt. In Japanese Patent Laid-Open No. 10/025,699, there is disclosed a material paper for wrapping and a corrugated cardboard which are made antibacterial by application of potassium sorbate. In Japanese Patent Laid-Open No. 10/280,298, there is disclosed an antibacterial paper in which E-polylysine is attached to or permeated into paper. In Japanese Patent Laid-Open No. 10/298,898, there is disclosed an antibacterial paper in which fibrous chitin and pulp are mixed. In Japanese Patent Laid-Open No. 2000/110,099, there is disclosed an antibacterial paper for food in which an antibacterial agent which contains catechin of a tea extract and quinone of an extract of Phyllostachys pubescens as components is applied on the surface.

As mentioned above, those wrapping materials and underlays use materials of a cellulose type and, when their influence on environment is taken into consideration, it goes without saying that they are better. However, there is a problem which is common in all of those disclosed methods that, in all of them, a chemical substance or metal having an antibacterial action is contained by means of application, permeation, etc., and consequently the bonding of the cellulose-type material to the antibacterial agent is loose whereby there is a possibility of elution by a liquid being oozed out from the food or of detachment by rubbing against the food. There is another problem that, when the antibacterial component is metal, it remains as a residue after burning. Thus, there remains a need for improved wrapping materials and underlays which do not suffer from these drawbacks.

### SUMMARY OF THE INVENTION

Accordingly, it is one object of the present invention to provide novel wrapping materials and underlays.

It is another object of the present invention to provide novel wrapping materials and underlays which have excellent antibacterial properties and a high safety.

It is another object of the present invention to provide novel wrapping materials and underlays which have a reduced tendency to leech harmful substances.

It is another object of the present invention to provide novel wrapping materials and underlays which have a reduced tendency to leave a metal-containing residue or ash on burning.

It is another object of the present invention to provide novel methods for preparing such wrapping materials and underlays.

It is another object of the present invention to provide novel methods for packaging food with such wrapping materials and underlays.

It is another object of the present invention to provide novel packaged foods in which the packaging contains such a wrapping material or underlay.

These and other objects, which will become apparent during the following detailed description, have been achieved by the inventors' discovery that, when a wrapping material or an underlay or a part of it is made from or comprises a partial ester of at least one basic amino acid with cellulose or a salt thereof, the above-mentioned objects are achieved.

### DETAILED DESCRIPTION OF THE PREFERRED EMBODIMENTS

Thus, in a first embodiment, the present invention provides wrapping materials or underlays in which a partial ester of at least one basic amino acid with cellulose or a salt thereof is a constituting component.

The partial ester of at least one basic amino acid with cellulose or a salt thereof which is used in the present invention has a structure in which a carboxyl group of a basic amino acid forms a covalent bond (ester bond) with a portion of the hydroxyl groups of a cellulose molecule. In other words, a portion of the hydroxyl groups in the cellulose are esterified with one or more basic amino acids. Therefore, the cellulose and amino acid do not form a mere adhesion but, instead, a strong chemical bond, and, even when used as a wrapping material for perishable foods containing a high amount of water, it is believed that neither elution by a liquid being oozed out from the food nor detachment by rubbing against the food takes place. In addition, even when the ester bond is cleaved, the component which is detached is an amino acid which is nontoxic to a living body and, therefore, it is believed that the safety is very high.

Examples of the basic amino acid moiety in the partial ester of at least one basic amino acid with cellulose are lysine, arginine, ornithine, and histidine residues and it is also possible to use a mixture thereof.

The cellulose which is a material for the partial ester of at least one basic amino acid with cellulose may be either natural cellulose or regenerated cellulose. Examples of its form include powder, fiber, cloth, nonwoven fabric, wood, and paper in the case of natural cellulose, while in the case of regenerated cellulose, they include powder, fiber, cloth, nonwoven fabric, and film. Incidentally, the cellulose used here may be subjected to a pretreatment using, for example, an alkali by a common method.

The degree of substitution with the ester groups (DS; average number of ester substituents per anhydroglucose unit (AGU)) for the partial ester of the basic amino acid with cellulose or a salt thereof is from 0.0001 to less than 3, preferably from 0.001 to 1.

Specific examples of the partial ester of at least one basic amino acid with cellulose used in the present invention are a partial ester of lysine with cellulose, a partial ester of arginine with cellulose, a partial ester of ornithine with cellulose, and a partial ester of histidine with cellulose.

Examples of the salt of the partial ester of at least one basic amino acid with cellulose include salts with one or more anions of an organic acid such as acetate, lactate, malate, tartrate, succinate, citrate, benzoate, pyrrolidonecarboxylate, and mixtures thereof; salts with one or more anions of an inorganic acid such as chloride, sulfate, phosphate, and mixtures thereof; and salts with one or more Lewis acids such as boron trifluoride.

The partial ester of at least one basic amino acid with cellulose used in the present invention may be prepared, for example, by the following method. Thus, cellulose is contacted with a treating solution containing a basic amino acid ester and then subjected to liquid removal and drying in an appropriate manner. After that, a heating treatment is carried out and then an after-treatment such as washing is carried out in order to remove the unreacted basic amino acid ester. It is further possible to make the partial ester of basic amino acid with cellulose into a salt when the corresponding acid is used in a step after the heating treatment.

Specific examples of the basic amino acid ester used for the above-mentioned treating solution are C₁₋₆ lower alkyl esters. With regard to the treating agent solution, the basic amino acid ester may be dissolved or dispersed in a liquid comprising water, alcohol (e.g., a lower alcohol such as methanol or ethanol), or a mixture thereof. When the basic amino acid ester is a salt such as a hydrochloride or sulfate, it may be neutralized, if necessary, with alkali hydroxide in an amount of 10 to 200 molar % of the basic amino acid ester. The amount of the basic amino acid ester in the treating solution is not limited so long as it is within such a range that it is able to be dissolved or dispersed. Cellulose is permeated with the treating solution, then the liquid is removed if necessary and air-drying or drying with heating is appropriately carried out. After that, the mixture is heated at 100 to 200° C. or, preferably, at 120 to 180° C. for 10 seconds to 100 minutes or, preferably, for 1 to 60 minute(s) and then subjected to washing and drying treatments to give the partial ester of the basic amino acid with cellulose. The washing may be carried out in the order of first with water, then with an alkaline aqueous solution such as sodium bicarbonate, and an aqueous organic acid solution such as citric acid, and finally with water; although one or more of the washes may be omitted. During the washing with an aqueous solution of organic acid, the basic amino acid which is bonded to cellulose to form an ester forms a salt and, therefore, when the washing with an aqueous solution of organic solvent is carried out, the product may be obtained as an organic acid salt of the partial ester of the basic amino acid with cellulose.

In accordance with the present invention, it is now possible to provide wrapping materials and underlays which have excellent antibacterial properties and a high safety in which a partial ester of at least one basic amino acid with cellulose or a salt thereof is a constituting component.

The wrapping materials and underlays according to the present invention are able to be used as wrapping materials for foods, particularly as a wrapping of an individual item, an inner wrapping, an outer wrapping, an underlay, etc. of processed foods such as ham, sausage, kamaboko (processed fish meat paste), household dishes, packed luncheons, and confectioneries; or as a wrapping of an individual item, an inner wrapping, an outer wrapping, an underlay, etc. of perishable foods such as meat, fowl (avian meat), fish, vegetables, and fruits.

The wrapping materials and underlays according to the present invention can also be used as wrapping materials or underlays for sanitary goods such as paper diapers, adult incontinence pads, sanitary napkins, sanitary tampons, panty sheets, sweat-absorbing pads, breast milk pads, and wet wipes.

The wrapping materials and underlays according to the present invention are further able to be used as wrapping materials and underlays for medical supplies such as cotton swabs, first-aid bandages, surgical dressings, medical tampons, medical masks, gauze, bandages, medical sheets, medical towels, medical drapes, gowns for operators, clothing for patients, medical caps, medical aprons, and medical covers.

The wrapping material or underlay of the present invention may be anything so long as a partial ester of at least one basic amino acid with cellulose or a salt thereof is compounded at least as a part of the product while other parts may adopt the conventionally known structures or materials. For example, when it is used as an underlay for wrapping of perishable foods such as meat, fowl (avian meat), fish, vegetables, and fruit, the partial ester of at least one basic amino acid with cellulose or a salt thereof may be compounded in a part of an absorbent which absorbs the liquid being oozed out from the food.

The term “underlay” used in the present invention includes not only that which is laid under the content but also that which is placed in an upper area, a side area or an inner area of the content and that which is used for partitioning the contents up and down, right and left, or front and back.

Other features of the invention will become apparent in the course of the following descriptions of exemplary embodiments which are given for illustration of the invention and are not intended to be limiting thereof.

### EXAMPLES

In the following examples, and throughout this specification, all parts and percentages are by weight, and all temperatures are in degrees Celsius, unless expressly stated to be otherwise. Where the solids content of a dispersion or solution is reported, it expresses the weight of solids based on the total weight of the dispersion or solution, respectively.

### Manufacturing Example 1

### Manufacture of a Citrate of a Partial Ester of L-Lysine with Cellulose

L-Lysine methyl ester dilhydrochloride (2.33 g, 10 mmol) was dissolved in 15 ml of methanol, and 5 ml of 2N aqueous solution of sodium hydroxide were added thereto to prepare a treating solution. Cotton nonwoven fabric (5.0 g) (CX 32 manufactured by Haniron K. K.) was permeated with the treating solution, air-dried for 1 hour, and heated at 140° C. for 20 minutes. This was washed with water, then rinsed with a 5% aqueous sodium bicarbonate solution and water three times, rinsed with a 10% aqueous solution of citric acid and water three times, dehydrated and air-dried to give a sample. A part of the sample was dried in vacuo at 50° C. for one night and about 0.5 g thereof was precisely weighed and was subjected to an alkali hydrolysis by stirring in 50 ml of 0.5N sodium hydroxide at room temperature for 18 hours. The fiber was filtered off, and a quantitative determination of L- lysine was carried out using an amino acid analyzer (L-8500 manufactured by Hitachi). The bonding amount of L-lysine per gram of the sample was calculated from the above result as 0.105 mmol. The bonding amount of citric acid per gram of the sample was calculated from the result of a quantitative determination of citric acid from the same sample solution by means of HPLC as 0.190 mmol.

### Manufacturing Example 2

### Manufacture of a Citrate of a Partial Ester of L-Arginine with Cellulose

The same experiment as in Manufacturing Example 1 was carried out using 2.61 g (10 mmol) of L-arginine methyl ester dihydrochloride instead of the L-lysine methyl ester dihydrochloride used in Manufacturing Example 1. When the bonding amounts of L-arginine and citric acid in 1 g of the sample were calculated by the same methods as in Manufacturing Example 1, they were found to be 0.109 mmol and 0.162 mmol, respectively.

### Example 1.

Underlays for perishable foods were prepared using a nonwoven fabric of the citrate of the partial ester of L-lysine with cellulose of Manufacturing Example 1, a nonwoven fabric of the citrate of the partial ester of L-arginine with cellulose of Manufacturing Example 2, and a non-processed nonwoven fabric.

Incidentally, the water-absorbing properties of the three underlays were compared with an assumption of the case of wrapping of meat, fowl (avian meat), or fish, but there is no difference between the underlays for perishable foods prepared by using a nonwoven fabric of the citrate of the partial ester of L-lysine or L-arginine with cellulose and the underlay for perishable foods prepared by using a non-processed non-woven fabric in terms of their water-absorbing property.

### Test Example 1.

Square pieces each having about 18 mm side were prepared from those underlays for perishable foods and their antibacterial properties were assessed in accordance with the process mentioned in “JIS L 1902:1998 ‘Antibacterial Test Method for Fiber Products’ 8. Quantitative Test”. With regard to the test microorganisms, Staphylococcus aureus (ATCC 6538 P) and Klebsiella pneumoniae (ATCC 4352) were used. Each of the samples was sterilized with high-pressure steam, inoculated with a predetermined amount (about 2.5×10⁴ cells) of the microorganism suspended in a nutrient broth medium, and incubated at 37° C. for 18 hours, and then the numbers of the living cells were determined for each sample.

As to the formulae for JIS L 1902:1998, the followings are mentioned:

F=M_{b}−Mₐ;

S=M_{b}−M_{c}; and

L=Mₐ−M_{c}

In the formulae, F is the proliferation value; S is the bacteriostatic activity value; L is the bactericidal activity value; Mₐ is the common logarithm of the number of living cells immediately after inoculation of a non-processed sample (an average of three samples); M_{b} is the common logarithm of the number of living cells after incubation of a non-processed sample for 18 hours (an average of three samples); and M_{c} is the common logarithm of the number of living cells after incubation of a processed sample for 18 hours (an average of three samples). Proliferation values, bacteriostatic activity values and bactericidal activity values were calculated from the above, and the results are shown in Tables 1 and 2 below.

TABLE 1
Antibacterial Test Results of an Underlay for Perishable Foods
Prepared by Using the Nonwoven Fabric of Manufacturing
Example 1

| | | |
|---|---|---|
| Tested Microorganism | Staphylococcus | Klebsiella |
| Species | aureus | pneumoniae |
| (Accession Numbers) | (ATCC 6538 P) | (ATCC 4352) |
| Invested Microorganism | 2.5 × 10⁴ | 2.5 × 10⁴ |
| Concentration (cells/ml) | | |
| Living Cells after | <20 | <20 |
| 18 Hours (cells/ml) | | |
| Proliferation Value (F) | 2.8 | 3.3 |
| Bacteriostatic Activity | >5.9 | >6.4 |
| Value (S) | | |
| Bactericidal Activity | >3.1 | >3.1 |
| Value (L) | | |

TABLE 2
Antibacterial Test Results of an Underlay for Perishable Foods
Prepared by Using the Nonwoven Fabric of Manufacturing
Example 2

| | | |
|---|---|---|
| Tested Microorganism | Staphylococcus aureus | Klebsiella pneumoniae |
| Species | | |
| (Accession Numbers) | (ATCC 6538 P) | (ATCC 4352) |
| Invested Microorganism | 2.5 × 10⁴ | 2.5 × 10⁴ |
| Concentration (cells/ml) | | |
| Living Cells after | 1.9 × 10² | <20 |
| 18 Hours (cells/ml) | | |
| Proliferation Value (F) | 2.8 | 3.3 |
| Bacteriostatic Activity | 4.9 | >6.4 |
| Value (S) | | |
| Bactericidal Activity | 2.1 | >3.1 |
| Value (L) | | |

As a result of those tests, it was confirmed that the underlays for perishable foods prepared from nonwoven fabric of citrates of partial ester of L-lysine and L-arginine with cellulose showed a sufficient antibacterial activity.

### Test Example 2.

A piece (0.422 g) of an underlay for perishable foods using a nonwoven fabric of the citrate of the partial ester of L-lysine with cellulose prepared in Manufacturing Example 1 was shaken in 10 ml of water at room temperature to carry out an elution test. When the eluted components were analyzed by HPLC, elutions of 0.0098 mmol and 0.0130 mmol of L-lysine per gram of the piece were noted after 1 hour and 5 hours, respectively. No other eluate than L-lysine was noted.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A wrapping material or an underlay, comprising a partial ester of at least one basic amino acid with cellulose or a salt thereof.

2. The wrapping material or underlay of claim 1, wherein said partial ester of at least one basic amino acid with cellulose or a salt thereof is at least one member selected from the group consisting of a partial ester of lysine with cellulose, a partial ester of arginine with cellulose, a partial ester of ornithine with cellulose, a partial ester of histidine with cellulose, a salt of a partial ester of lysine with cellulose, a salt of a partial ester of arginine with cellulose, a salt of a partial ester of ornithine with cellulose, a salt of a partial ester of histidine with cellulose, and mixtures thereof.

3. The wrapping material or underlay of claim 1, wherein said wrapping material or underlay comprises a salt of a partial ester of at least one basic amino acid with cellulose.

4. The wrapping material or underlay of claim 3, wherein said salt of a partial ester of at least one basic amino acid with cellulose is at least one member selected from the group consisting of a salt with one or more anions of an organic acid, a salt with one or more anions of an inorganic acid, a salt with one or more Lewis acids, and mixtures thereof.

5. The wrapping material or underlay of claim 3, wherein said salt of a partial ester of at least one basic amino acid with cellulose is a salt with one or more anions of an organic acid.

6. The wrapping material or underlay of claim 1, wherein said partial ester of at least one basic amino acid with cellulose or a salt thereof has a degree of substitution of from 0.0001 to less than 3.

7. A method of producing the wrapping material or underlay of claim 1, said method comprising:
(1) contacting cellulose with a liquid comprising at least one basic amino acid ester or a salt thereof, to obtain a mixture; and
(2) heating said mixture to obtain said wrapping material or an underlay.

8. The method of claim 7, wherein said mixture is subjected to drying prior to said heating.

9. The method of claim 7, wherein said heating is carried out at a temperature of 100 to 200° C. for a time of 10 seconds to 100 minutes.

10. The method of claim 7, wherein said at least one basic amino acid ester or a salt thereof is at least one member selected from the group consisting of a C₁₋₆ lower alkyl ester of lysine, a C₁₋₆ lower alkyl ester of arginine, a C₁₋₆ lower alkyl ester of ornithine, a C₁₋₆ lower alkyl ester of histidine, a salt of a C₁₋₆ lower alkyl ester of lysine, a salt of a C₁₋₆ lower alkyl ester of arginine, a salt of a C₁₋₆ lower alkyl ester of ornithine, a salt of a C₁₋₆ lower alkyl ester of histidine, and mixtures thereof.

11. A method of packaging food, said method comprising packaging food in a package which comprises a wrapping material or underlay according to claim 1.

12. The method of claim 11, wherein said partial ester of at least one basic amino acid with cellulose or a salt thereof is at least one member selected from the group consisting of a partial ester of lysine with cellulose, a partial ester of arginine with cellulose, a partial ester of ornithine with cellulose, a partial ester of histidine with cellulose, a salt of a partial ester of lysine with cellulose, a salt of a partial ester of arginine with cellulose, a salt of a partial ester of omithine with cellulose, a salt of a partial ester of histidine with cellulose, and mixtures thereof.

13. The method of claim 11, wherein said wrapping material or underlay comprises a salt of a partial ester of at least one basic amino acid with cellulose.

14. The method of claim 13, wherein said salt of a partial ester of at least one basic amino acid with cellulose is at least one member selected from the group consisting of a salt with one or more anions of an organic acid, a salt with one or more anions of an inorganic acid, a salt with one or more Lewis acids, and mixtures thereof.

15. The method of claim 13, wherein said salt of a partial ester of at least one basic amino acid with cellulose is a salt with one or more anions of an organic acid.

16. The method of claim 11, wherein said partial ester of at least one basic amino acid with cellulose or a salt thereof has a degree of substitution of from 0.0001 to less than 3.

17. A packaged food, wherein said food is packaged in a package which comprises a wrapping material or underlay according to claim 1.

18. The packaged food of claim 17, wherein said partial ester of at least one basic amino acid with cellulose or a salt thereof is at least one member selected from the group consisting of a partial ester of lysine with cellulose, a partial ester of arginine with cellulose, a partial ester of ornithine with cellulose, a partial ester of histidine with cellulose, a salt of a partial ester of lysine with cellulose, a salt of a partial ester of arginine with cellulose, a salt of a partial ester of ornithine with cellulose, a salt of a partial ester of histidine with cellulose, and mixtures thereof.

19. The packaged food of claim 17, wherein said wrapping material or underlay comprises a salt of a partial ester of at least one basic amino acid with cellulose.

20. The packaged food of claim 19, wherein said salt of a partial ester of at least one basic amino acid with cellulose is at least one member selected from the group consisting of a salt with one or more anions of an organic acid, a salt with one or more anions of an inorganic acid, a salt with one or more Lewis acids, and mixtures thereof.

21. The packaged food of claim 19, wherein said salt of a partial ester of at least one basic amino acid with cellulose is a salt with one or more anions of an organic acid.

22. The packaged food of claim 17, wherein said partial ester of at least one basic amino acid with cellulose or a salt thereof has a degree of substitution of from 0.0001 to less than 3.
